(19) United States
(12) Patent Application Publication
(10) Pub. No.: US 2022/0078339 A1
(43) Pub. Date: Mar. 10, 2022

(54) METHOD FOR OBTAINING PICTURE FOR MEASURING BODY SIZE AND BODY SIZE MEASUREMENT METHOD, SERVER, AND PROGRAM USING SAME

(71) Applicant: IDICTION CO., LTD., Daejeon (KR)

(72) Inventor: Jaemin YANG, Daejeon (KR)

(21) Appl. No.: 17/417,741

(22) PCT Filed: Dec. 11, 2019
(86) PCT No.: PCT/KR2019/017489

§ 371 Date: Jun. 23, 2021

(30) Foreign Application Priority Data
Jan. 3, 2019 (KR) 10-2019-0000925
Aug. 19, 2019 (KR) 10-2019-0100971

(51) Int. Cl. H04N 5/232; G06K 9/20; G06K 9/00; G06K 9/46; G06T 7/194; G06T 7/60; G06K 9/40; G06Q 30/06; A41H 1/02

(52) U.S. Cl. CPC H04N 5/23222; G06K 9/2063; G06K 9/00369; G06K 9/00375; G06K 9/4604; G06T 2207/30196; G06T 7/60; G06K 9/40; G06Q 30/0643; A41H 1/02; G06T 2207/20081; G06T 7/194

(57) ABSTRACT

The present invention relates to a method for obtaining a picture for measuring a body size and a body size measurement method using same, wherein, by providing a guiding line through a capturing screen of a terminal, an optical image for measuring a body size is obtained, and the edge of a user body is extracted from the obtained image and used to obtain a 3D image of the user body, and thus an accurate body size of a user may be calculated.

### FIELD OF INVENTION

The present invention relates to a method of acquiring an image for measuring a body size, and a method of measuring a body size using the method of acquiring an image.

### BACKGROUND OF INVENTION

Conventionally, most people visit offline stores and try on clothes before purchasing, and thus clothes of the wrong size are rarely chosen.

However, in recent years, the number of people purchasing clothes through online shopping has increased rapidly, and in this case, the size of the clothes is often wrong.

An increasing number of companies are disclosing the actual size of clothes along with photos of clothes, but there is a problem in that consumers are not capable of knowing exactly their detailed body size.

Needless to say, most people know their body size, such as their weight and height, but there is a problem that it is difficult to purchase clothes online with only these two pieces of information.

Therefore, there is a need for a method of measuring an exact body size of a user in order to implement technology for virtual wearing thorough comparison with an actual size of clothes.

### SUMMARY OF INVENTION

### Technical Problem to be Solved

To overcome the problem, according to the present invention, a guideline may be provided through a photographing screen of a user terminal, and thus a user may be induced to take a specific posture at a specific distance to photograph the body of the user.

According to the present invention, an edge (outline) of the body of the user may be extracted using the captured image, and a 3D image of the body of the user may be acquired using the extracted edge to acquire the body size.

The technical problems solved by the embodiments are not limited to the above technical problems and other technical problems which are not described herein will become apparent to those skilled in the art from the following description.

### Technical Solution

According to an embodiment of the present invention, a method of acquiring an image for measuring a body size, performed by a server, includes an image acquisition operation of acquiring front and side images of a user, captured through a photographing device of a terminal, wherein the front and side images are captured in a state in which a body of the user in a photographing screen of the terminal is positioned in a range of a guideline displayed on the photographing screen of the terminal.

The guideline may induce the user to take a specific posture at a specific distance from the terminal and has a shape of a front or a side of a human body, a front guideline may have a shape with a user's arm extended at a predetermined angle from a torso and both user's legs separated by a predetermined angle, and the server may adjust a shape and size of the guideline in consideration of information on the body of the user.

According to another embodiment of the present invention, a method of measuring a body size using the image acquired using the method of claim 1, performed by the server, includes recognizing a region corresponding to the body of the user from the front and side images of the user, separating an edge of the recognized region from a background, and extracting the edge, analyzing the extracted edge and selecting a 3D standard body model corresponding to the edge, by an image analysis module, and acquiring the body size of the user using the selected 3D standard body model, wherein the image analysis module learns a method of generating the 3D standard body model using the front and side images of the body by inputting the front and side images and 3D images of the bodies of models having different physical conditions.

The method may further include, subsequent to the selecting the 3D standard body model, correcting the selected 3D standard body model in consideration of at least one of an analysis result of information of the body of the user or an analysis result of the edge, by the image analysis module, wherein the image acquisition operation may include acquiring the body size of the user using the corrected 3D standard body model.

The server may ask the user accessing the server to input information on whether a weight changes at regular intervals, and when there is a change in the user's weight by more than a critical ratio, the body size of the user may be acquired again using a first method of requesting rephotographing to the user or a second method of recorrection of the corrected 3D standard body model in consideration of the weight change of the user.

The extracting may include, when recognition of the region corresponding to the user's body in the image fails or the extracted edge does not correspond to a normal body shape, requesting rephotographing after posture correction to the user or requesting rephotographing after changing clothes to the user.

The extracting may include determining an image of clothes worn by the user as noise in the recognized region of the body of the user and removing the image.

According to another embodiment of the present invention, a server includes an image acquisition module configured to acquire front and side images of a user, captured through a photographing device of a terminal, wherein the front and side images are captured in a state in which a body of the user in a photographing screen of the terminal is positioned in a range of a guideline displayed on the photographing screen of the terminal.

The server may further include an edge extractor configured to recognize a region corresponding to the body of the user from the front and side images of the user, to separate an edge of the recognized region from a background, and to extract the edge, an image analysis module configured to analyze the extracted edge and to select a 3D standard body model corresponding to the edge, and a calculator configured to acquire the body size of the user using the selected 3D standard body model, wherein the image analysis module learns a method of generating the 3D standard body model using the front and side images of the body by inputting the front and side images and 3D images of the bodies of models having different physical conditions.

In addition, another method, and another system for implementing the present invention, and a computer readable recording medium for recording a computer program for executing the method may be further provided.

### Effect of Invention

As described above, according to the present invention, an optimal image for measuring a body size may be acquired by providing a guideline through a photographing screen of a user.

According to the present invention, as described above, an edge of the body of a user may be extracted using an accurately captured 2D image, and a 3D image of the body of the user may be acquired using the extracted edge, and thus the size of the entire body of the user may be accurately measured with only a few photographing operations.

It will be appreciated by persons skilled in the art that that the effects that could be achieved with the present invention are not limited to what has been particularly described hereinabove and other advantages of the present invention will be more clearly understood from the detailed description.

### BRIEF DESCRIPTION OF DRAWINGS

FIG. 1 is a flowchart of a method of acquiring an image for measuring a body size according to an embodiment of the present invention.

FIG. 2 is a diagram showing an example of a guideline displayed on a photographing screen of a user terminal during an image acquisition procedure.

FIG. 3 is a diagram showing an example in which a user performs photography on the body using a user terminal.

FIG. 4 is a flowchart of a method of measuring a body size according to an embodiment of the present invention.

FIG. 5 is a diagram showing an example of a 3D standard body model of a user selected by an image analysis module using a captured image of a user.

FIG. 6 is a block diagram of a server according to an embodiment of the present invention.

### BEST MODE

The attached drawings for illustrating exemplary embodiments of the present invention are to be referred to in order to gain a sufficient understanding of the present invention, the merits thereof, the objectives accomplished by the implementation of the present invention, and a method of achieving the same. The present invention may, however, be embodied in many different forms, and should not be construed as being limited to the embodiments set forth herein; rather, these embodiments are provided so that this disclosure will be thorough and complete, and will fully convey the concept of the present invention to one of ordinary skill in the art.

Terms used in this disclosure are used to describe specified embodiments and are not intended to limit the scope of another embodiment. The terms of a singular form may include plural forms unless otherwise specified. It will be further understood that the terms “comprises” and/or “comprising,” when used in this specification, specify the presence of stated components, but do not preclude the presence or addition of one or more other components. Like reference numerals in the drawings denote like elements, and the term “and/or” includes any and all combinations of one or more of the associated listed items. It will be understood that, although the terms first, second, third etc. may be used herein to describe various elements, these elements should not be limited by these terms. These terms are only used to distinguish one element from another element. Accordingly, a first element may be termed a second element without departing from the teachings of the present invention.

Unless otherwise defined, all terms including technical and scientific terms used herein have the same meaning as commonly understood by one of ordinary skill in the art to which this present invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, an embodiment of the present invention will be described in detail with reference to the accompanying drawings.

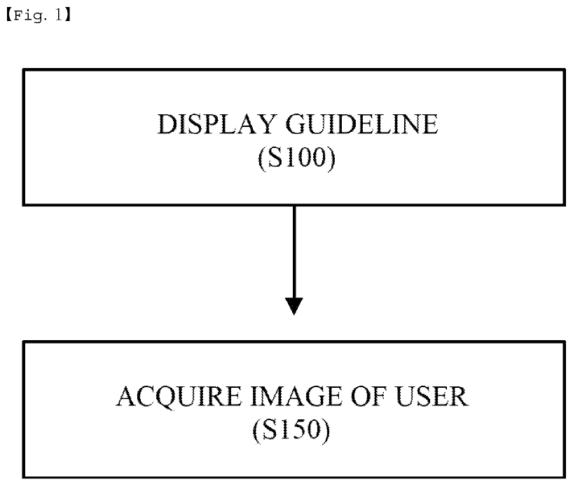

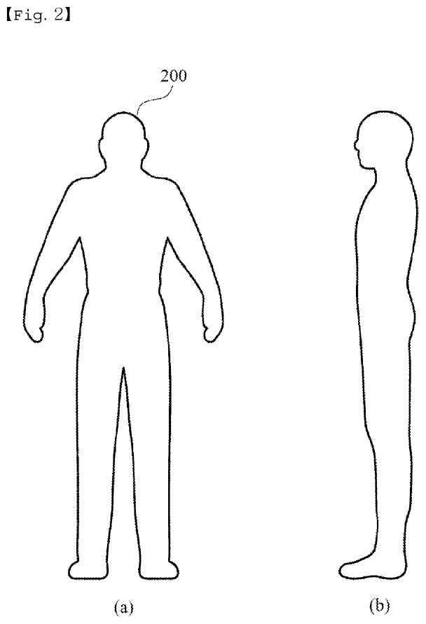

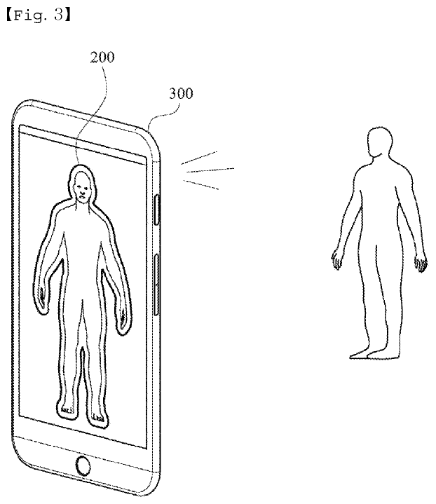

FIG. 1 is a flowchart of a method of acquiring an image for measuring a body size according to an embodiment of the present invention. FIG. 2 is a diagram showing an example of a guideline 200 displayed on a photographing screen of a user terminal 300 during an image acquisition procedure. FIG. 3 is a diagram showing an example in which a user performs photography on the body using the user terminal 300.

With reference to FIGS. 1 to 3, a method of acquiring an image for measuring a body size according to an embodiment of the present invention will be described.

First, a guide provision module 110 of a server 100 may display the guideline 200 on the photographing screen of the terminal 300 (operation S100).

An image acquisition module of the server 100 may acquire front and side images of the user, photographed by a photographing device of the terminal 300 (operation S150).

In more detail, referring to FIG. 3, the front and side images of the user, acquired by the image acquisition module of the server 100, may be captured in the state in which the body of the user being photographed is positioned in a range of the guideline 200 on the photographing screen of the terminal 300. In this case, the guideline 200 may be displayed on the photographing screen of the terminal 300 and may induce the user to take a specific posture at a specific distance from the terminal 300.

The server 100 according to an embodiment of the present invention may provide a service application stored in a medium for executing a method according to an embodiment of the present invention.

Accordingly, hereinafter, according to an embodiment of the present invention, when an operation is performed by the terminal 300, this immediately means that the operation is performed through the service application.

When the user executes the service application and activates a photographing function, a camera of the terminal 300 may be activated and the photographing screen may be turned on, as shown in FIG. 3. The service application may display the guideline 200 on the photographing screen of the terminal 300 as pre-programed.

In this case, according to an embodiment of the present invention, displaying of the guideline 200 on the photographing screen may be programmed by the guide provision module 110 in the service application provided by the server 100, and whenever the service application is driven, the guide provision module 110 of the server 100 may control display of the guideline 200 on the photographing screen. The implementation of the guide provision module 110 may be easily selected according to a situation by an implementer of the invention.

When the user installs and drives the service application in order to measure a body size, the guide provision module 110 may display the guideline 200 on the photographing screen of the terminal 300 through the service application.

FIG. 2A is a diagram showing an example of a front guideline 200 for capturing a front image of the body to a user. FIG. 2B is a diagram showing an example of a side guideline 200 for capturing a side image of the body.

The user may visually check the front guideline 200 displayed on the photographing screen of the terminal 300 and may adjust his or her posture to position the body in the front guideline 200, as shown in FIG. 3, and the guide provision module 110 may detect that the user's body is exactly positioned in the front guideline 200 to automatically capture a front image of the user.

Upon determining that the front image of the user is properly acquired, the guide provision module 110 may display the side guideline 200 on the photographing screen of the terminal 300 to induce the user to change the posture, and upon determining that a side of the body of the user is positioned in the guideline 200, the guide provision module 110 may automatically acquire the side image of the user.

In this case, the server 100 may automatically acquire the image of the user as described above, but may acquire the image of the user using various methods including a method of capturing the image by setting a timer, a method of capturing the image by clicking a photographing button by another user, and a method of capturing the image through remote adjustment of the user.

An order in which the server 100 acquires the front and side images is not limited, and the number of images for acquiring the front or side image may also be changed according to embodiments of the present invention.

For example, the image acquisition module of the server 100 may acquire both left and right side images of the user or may acquire only one side image.

The guideline 200 according to an embodiment of the present invention may have a shape with both arms extended at a predetermined angle from the torso and both legs separated by a predetermined angle.

The guideline 200 may have such a shape because, when the user's arm is attached to the torso, it is difficult to separate the arm and the torso in the image and many errors occur in this process.

In addition, this is because, when an angle between the user's arm and torso is set to be excessively large in this process, it is difficult to separate the user's torso and arm from the shoulder part on the image and errors occur again in this process.

Accordingly, the server 100 according to an embodiment of the present invention may provide the guideline 200 based on an algorithm calculated to accurately calculate a body size of the user using front and side images later, not only for inducing the user to take a specific posture at a specific distance from the terminal 300 by displaying the guideline 200.

According to an embodiment, for this implementation, the server 100 may receive information on the height and weight of the user through the terminal 300 and may adjust the shape and size of the guideline 200 in consideration of the received information.

Accordingly, the server 100 may adjust an arm angle of the guideline 200 in consideration of the user's body information input through the terminal 300.

In more detail, the server 100 may set the width of the guideline 200 wider and may increase the angle between the arm and the torso as the weight input by the user is higher.

For example, this is because, if a person weighing 100 kg stands with his or her arms spread apart from the torso in the same way as a person weighing 45 kg, the torso and the arms overlap due to the thickness of the torso and the arms.

In addition, in the case of a user who weighs more than average, an error may occur because the body exceeds the guideline 200, and accordingly, for users whose weight exceeds a standard range, the guideline 200 may be corrected and displayed on the photographing screen.

As described above, an image to be used in a method of measuring a body size to be described below may be acquired using the method of acquiring an image for measuring a body size according to the embodiment of the present invention described with reference to FIGS. 1 to 3.

Hereinafter, the method of measuring a body size according to an embodiment of the present invention will be described with reference to other drawings.

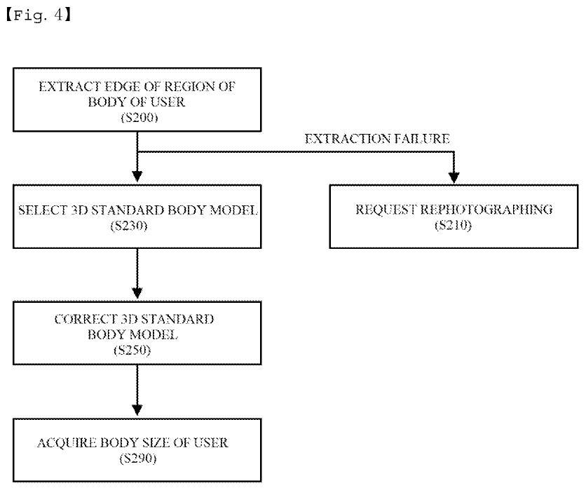

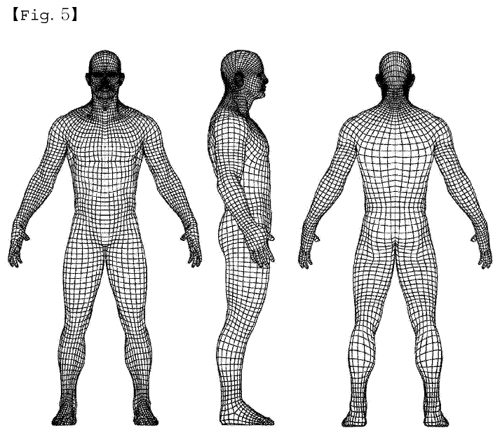

FIG. 4 is a flowchart of a method of measuring a body size according to an embodiment of the present invention. FIG. 5 is a diagram showing an example of a 3D standard body model of a user selected by an image analysis module 140 using a captured image of a user.

With reference to FIGS. 4 and 5, the method of measuring a body size according to an embodiment of the present invention will be described.

The method of measuring a body size according to an embodiment of the present invention may be performed by the server 100, and the body size may be measured using an image acquired using the method of acquiring an image for measuring the body size described with reference to FIGS. 1 to 3.

Thus, operations S100 and S150 above may be performed as a preceding operation before operation S200 below is performed.

First, an edge extractor 130 of the server 100 may recognize a region corresponding to the body of the user from the front and side images of the user and may separate an edge of the recognized region from a background and may extract the edge (operation S200).

In more detail, the front and side images of the user may be acquired using the guideline 200 through operations S100 and S150, but since the corresponding image contains a background in addition to the body of the user, the edge extractor 130 may extract an edge part corresponding to the body of the user region from the background in order to measure the body size of the user.

In this case, the edge extractor 130 may recognize that the body of the user is positioned in the guideline 200 on the image, and thus accuracy in the current case may be largely improved compared with the case in which an edge of the user body is extracted from a general image.

According to an embodiment, operation S200 may further include an operation of determining an image of clothes that the user wears as noise from the body of the user recognized in operation S200 by the edge extractor 130.

An ideal photographing method is a method of capturing front and side images in the state in which a user wears clothes that clearly show an outline of the body, but if the user wears clothes that do not clearly show an outline of the body, a process of determining the image of the clothes as noise and removing the image as described above.

Subsequent to operation S200, the image analysis module may analyze the edge extracted in operation S200 and may select a 3D standard body model corresponding thereto (operation S230).

In this case, by inputting front and side images and 3D images of bodies of models having different physical conditions, the image analysis module 140 may learn a method of generating a 3D standard body model using the front and side images of the bodies.

In more detail, the image analysis module 140 may learn a method of generating the 3D standard body model upon receiving front and side images of a specific user by inputting front and side images and 3D images of models who wear clothes that clearly show an outline of the body, and such training may be performed multiple times (hundreds or thousands of times or more) through images of models with different physical conditions, thereby ensuring accuracy.

Through this process, the image analysis module 140 may select the 3D standard body model of the user as shown in FIG. 5.

According to an embodiment, during S200, when the server 100 fails to recognize a region corresponding to the user's body in the image or the extracted edge does not correspond to a normal body shape, the server 100 may request rephotographing to the user after posture correction or after changing clothes.

In more detail, as described above, when recognition of the region corresponding to the user's body fails or the extracted edge does not correspond to the normal body shape, it may be determined that a user posture for photographing is not appropriate or the user is wearing clothes that are difficult to recognize by a computer, and rephotographing after posture correction may be requested to the user or rephotographing after changing clothes may be requested to the user.

Subsequent to operation S230, in consideration of at least one of the analysis result of information on the body of the user or the analysis result of the extracted edge, the image analysis module 140 may correct the 3D standard body model selected in operation S230 (operation S250).

In more detail, the 3D standard body model selected by the image analysis module 140 in operation S230 may be corrected to a user-optimized 3D model in consideration of at least one of the analysis result of information on the body of the user or the analysis result of the edge extracted in operation S200.

Accordingly, the 3D standard body model corrected in operation S250 may more precisely correspond to the body of the user than the 3D standard body model selected in operation S230.

Subsequent to operation S250, a calculator 150 may acquire the body size of the user using the 3D standard body model or the corrected 3D standard body model (operation S290).

The corrected 3D standard body model may be acquired from the 2D image of the user through the aforementioned operations S100 to S250, and thus the calculator 150 may be capable of acquiring the size of all body parts of the user using the corrected 3D standard body model.

Conventionally, in the case of tops, only fragmentary actual size information, such as a chest size, a full length, and an arm length, may be provided, and in the case of bottoms, only fragmentary actual size information, such as a full length, a hem width, a waist circumference, and a thigh circumference, may be provided.

In this method, an error occurs in many cases because the user has to measure the body size of the user himself or herself, resulting in failure to select the size in many cases.

However, when the present invention described above is used, it may be possible to ensure accurate data of the body of the user to select an accurate size by forming an accurate 3D standard body model of the user.

Also, it may be possible to accurately calculate the sizes of all body parts of the user using the 3D standard body model and to also fit the user for the clothes virtually, in reality.

According to an embodiment, the server 100 may ask a user accessing the server 100 to input information on whether the weight has changed at regular intervals, and when there is a change in the user's weight by more than a critical ratio, the body size of the user may be acquired again using a first method of requesting rephotographing to the user or a second method of recorrection of the corrected 3D standard body model in consideration of the weight change of the user.

For example, in the state in which a critical ratio of 10% is set in the server 100 and the 3D standard body model corrected when the weight of the user is 60 kg, if the weight input from the user after 5 months is 68 kg, the weight may exceed a critical ratio of 10%.

Thus, the server 100 may respond to the weight change of the user by acquiring the body size of the user again using the aforementioned first or second method, and thus, even if the weight of the user is changed, the body size may be acquired again depending on the change.

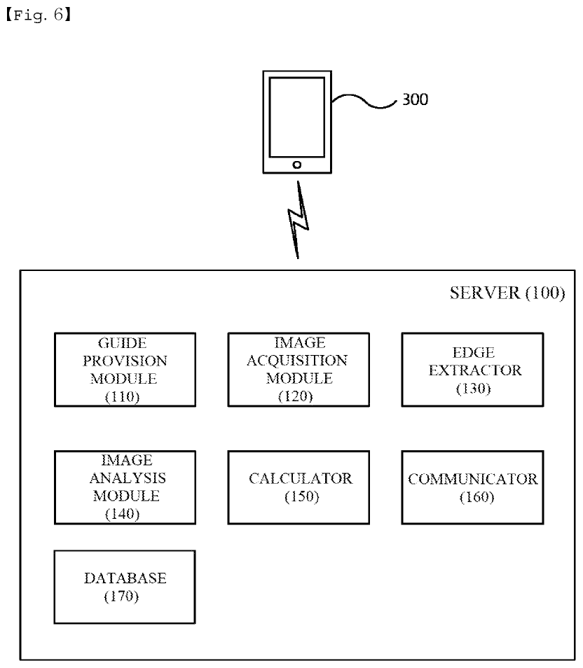

FIG. 6 is a block diagram of the server 100 according to an embodiment of the present invention.

The server 100 according to an embodiment of the present invention may refer to a subject that performs the aforementioned method of acquiring an image for measuring a body size and the aforementioned method of measuring a body size and may include the guide provision module 110, the image acquisition module, the edge extractor 130, the image analysis module 140, the calculator 150, a communicator 160, and a database 170.

However, in some embodiments, the server 100 may include greater or fewer components than those of FIG. 6.

The guide provision module 110 may display the guideline 200 for inducing the user to take a specific posture at a specific distance from the terminal 300 on the photographing screen of the terminal 300.

The image acquisition module may acquire front and side images of the user, captured through the photographing device of the terminal 300.

In this case, the communicator 160 may communicate with the terminal 300 and may transmit a control signal thereto to control a service application installed in the terminal 300 and may receive the captured image from the terminal 300.

The image analysis module 140 may analyze an edge extracted through the edge extractor 130 and may select a standard body model corresponding thereto.

In this case, the image analysis module 140 may learn a method of generating the 3D standard body model using the front and side images of the body by inputting the front and side images and 3D images of the bodies of models having different physical conditions.

The calculator 150 may acquire the body size of the user using the 3D standard body model selected through the image analysis module 140 or the corrected 3D standard body model.

The database 170 may store information on the body (height or weight) of the user, input from the user, and may store data such as the 3D standard body model and the corrected 3D standard body model of the user.

The aforementioned server 100 according to an embodiment of the present invention may be understood by the same description as the method of acquiring an image for measuring a body size and the method of measuring a body size, which have been described with reference to FIGS. 1 to 5, while only the categories are different, and thus repeated descriptions and examples are omitted.

The aforementioned method according to an embodiment of the present invention may be implemented as a program (or application) to be executed in combination with a server, which is hardware, and stored in a medium.

The aforementioned program may include code in a computer language such as C, C++, JAVA, or machine language, which is readable through a device interface of a computer, in order for the computer to read the program and to execute the methods implemented as a program. The code may include functional code related to a function defining functions necessary for executing the methods, etc. and may include execution procedure related control code necessary for the processor of the computer to execute the functions according to a predetermined procedure. In addition, the code may further include additional information necessary for the processor of the computer to execute the functions or code related to reference of a memory, for which location (address) in the internal or external memory of the computer is to be referenced. In addition, when the processor of the computer needs to communicate with any other computer or server located remotely in order to execute the above functions, the code may further include communication related code for a method of communication with any other computers or servers using the communication module of the computer or information or media to be transmitted or received during communication.

The stored media are not media that store data for a short moment, such as a register, cache, memory, etc., but are media that semi-permanently store data, and mean a medium that can be read by a device. In detail, examples of the stored media may include, but are not limited to, ROM, RAM, CD-ROM, magnetic tape, floppy disks, and optical data storage devices. That is, the program may be stored in various recording media on various servers accessible by the computer or in various recording media on the computer of the user. In addition, the media may be distributed in a computer system connected by a network, and computer-readable code may be stored in a distributed manner.

The operations of the method or algorithm described in relation to the embodiment of the present invention may be implemented directly in hardware, implemented as a software module executed by hardware, or a combination thereof. The software module may always be stored in random access memory (RAM), read only memory (ROM), erasable programmable ROM (EPROM), electrically erasable programmable ROM (EEPROM), flash memory, a hard disk, a removable disk, a CD-ROM, or any type of computer-readable recording medium that is well known in the art.

As mentioned above, although embodiments of the present invention have been described with reference to the accompanying drawings, those skilled in the art to which the present invention pertains are capable of implementing the present invention in other specific forms without changing the technical spirit or essential features thereof. Therefore, it should be understood that the embodiments described above are illustrative in all respects and not restrictive.

[Description of reference numerals]

| | |
|---|---|
| 100: server | 110: guide provision module |
| 120: image acquisition module | 130: edge extractor |
| 140: image analysis module | 150: calculator |
| 160: communicator | 170: database |
| 200: guideline | 300: terminal |

1. A method of acquiring an image for measuring a body size, performed by a server, the method comprising:
an image acquisition operation of acquiring front and side images of a user, captured through a photographing device of a terminal,
wherein the front and side images are captured in a state in which a body of the user in a photographing screen of the terminal is positioned in a range of a guideline displayed on the photographing screen of the terminal.

2. The method according to claim 1, wherein:
the guideline induces the user to take a specific posture at a specific distance from the terminal and has a shape of a front or a side of a human body;
a front guideline has a shape with a user's arm extended at a predetermined angle from a torso and both user's legs separated by a predetermined angle; and
the server adjusts a shape and size of the guideline in consideration of information on the body of the user.

3. A method of measuring a body size using the image acquired using the method of claim 1, performed by the server, the method comprising:
recognizing a region corresponding to the body of the user from the front and side images of the user, separating an edge of the recognized region from a background, and extracting the edge;
analyzing the extracted edge and selecting a 3D standard body model corresponding to the edge, by an image analysis module; and
acquiring the body size of the user using the selected 3D standard body model,
wherein the image analysis module learns a method of generating the 3D standard body model using the front and side images of the body by inputting the front and side images and 3D images of the bodies of models having different physical conditions.

4. The method according to claim 3, further comprising:
subsequent to the selecting the 3D standard body model, correcting the selected 3D standard body model in consideration of at least one of an analysis result of information of the body of the user or an analysis result of the edge, by the image analysis module,
wherein the image acquisition operation includes acquiring the body size of the user using the corrected 3D standard body model.

5. The method according to claim 4, wherein the server asks the user accessing the server to input information on whether a weight changes at regular intervals, and when there is a change in the user's weight by more than a critical ratio, the body size of the user is acquired again using a first method of requesting rephotographing to the user or a second method of recorrection of the corrected 3D standard body model in consideration of the weight change of the user.

6. The method according to claim 3, wherein the extracting includes:
when recognition of the region corresponding to the user's body in the image fails or the extracted edge does not correspond to a normal body shape, requesting rephotographing after posture correction to the user or requesting rephotographing after changing clothes to the user.

7. The method according to claim 3, wherein the extracting includes:
determining an image of clothes worn by the user as noise in the recognized region of the body of the user and removing the image.

8. A server comprising:
an image acquisition module configured to acquire front and side images of a user, captured through a photographing device of a terminal,
wherein the front and side images are captured in a state in which a body of the user in a photographing screen of the terminal is positioned in a range of a guideline displayed on the photographing screen of the terminal.

9. The server according to claim 8, further comprising:
an edge extractor configured to recognize a region corresponding to the body of the user from the front and side images of the user, to separate an edge of the recognized region from a background, and to extract the edge;
an image analysis module configured to analyze the extracted edge and to select a 3D standard body model corresponding to the edge; and
a calculator configured to acquire the body size of the user using the selected 3D standard body model,
wherein the image analysis module learns a method of generating the 3D standard body model using the front and side images of the body by inputting the front and side images and 3D images of the bodies of models having different physical conditions.

10. A non-transitory computer readable recording medium storing a program for acquiring an image for measuring a body size, the program instructing a computer to execute the method according to claim 1.
